(19) United States
(12) Patent Application Publication
(10) Pub. No.: US 2021/0178833 A1
(43) Pub. Date: Jun. 17, 2021

(54) PNEUMATIC TIRE AND MANUFACTURING METHOD THEREOF

(71) Applicant: TOYO TIRE CORPORATION, Itami-shi (JP)

(72) Inventor: Hiroshi Nashio, Itami-shi (JP)

(73) Assignee: TOYO TIRE CORPORATION, Itami-shi (JP)

(21) Appl. No.: 17/110,495

(22) Filed: Dec. 3, 2020

(30) Foreign Application Priority Data
Dec. 13, 2019 (JP) 2019-225705

(51) Int. Cl. B60C 15/00; B60C 15/06

(52) U.S. Cl. CPC B60C 15/0018; B60C 15/0603

(57) ABSTRACT

A pneumatic tire includes a carcass ply stretching between a pair of bead cores disposed on both sides in the tire width direction, and the carcass ply includes a pair of ply pieces disposed separately on both sides in the tire width direction. Each of a pair of the ply pieces has a joint portion in which both end portions in the tire circumferential direction are joined in a manner overlapping each other, and the respective joint portions of a pair of the ply pieces are provided at different positions in the tire circumferential direction.

### CROSS-REFERENCE TO RELATED APPLICATIONS

This application claims priority of Japanese Patent Application No.: 2019-225705 filed on Dec. 13 2019, the content of which is incorporated herein by reference.

### BACKGROUND OF THE INVENTION

### Technical Field

The present invention relates to a pneumatic tire and a manufacturing method of a pneumatic tire.

### Related Art

A carcass ply of a pneumatic tire disclosed in Japanese Patent No. 5629356 includes a first ply that is continuous between a pair of bead portions and a discontinuous second ply that is disposed on the outer side in the tire radial direction of the first ply. The second ply includes a pair of ply pieces extending from a tread portion to one of a pair of the bead portions. In the center of the tread portion, a region where neither of the two ply pieces exists, that is, a hollow portion is provided. The hollow portion of the second ply is intended to have two contradictory types of performance. One type of performance is rigidity (which contributes to improving steering stability) and cut resistance, and the other type of performance is weight reduction and rolling resistance reduction by the weight reduction.

### SUMMARY

The structure disclosed in Japanese Patent No. 5629356 can achieve the weight reduction and rolling resistance reduction by the weight reduction while ensuring rigidity and cut resistance. However, Japanese Patent No. 5629356 does not mention uniformity in the tire circumferential direction, and there is room for improvement in the uniformity in the tire circumferential direction.

An object of the present invention is to provide a pneumatic tire and a manufacturing method of a pneumatic tire, which can improve the uniformity in the tire circumferential direction.

The present invention provides a pneumatic tire including a carcass ply stretching between a pair of bead cores disposed on both sides in a tire width direction. The carcass ply includes a pair of ply pieces disposed separately on both sides in the tire width direction, each of the pair of ply pieces has a joint portion in which both end portions in a tire circumferential direction are joined in a manner overlapping each other, and respective joint portions of the pair of ply pieces are provided at different positions in the tire circumferential direction.

According to the present configuration, in a case where the carcass ply includes the pair of ply pieces disposed separately on both sides in the tire width direction, the two joint portions of a pair of the ply pieces are provided at different positions in the tire circumferential direction. For this reason, as compared with the case where the two joint portions are provided at the same position in the tire circumferential direction, the joint portions are dispersed in the tire circumferential direction and uniformity in the tire circumferential direction of the pneumatic tire can be improved.

The joint portion of the ply piece has increased rigidity as compared with the non-joint portion of the ply piece. For this reason, the joint portion of the ply piece is less likely to bulge and deform than the non-joint portion when the tire is filled with internal pressure and bulged and deformed. Therefore, the joint portion of the ply piece may appear as a dent in the pneumatic tire.

By providing the two joint portions of the pair of ply pieces at different positions in the tire circumferential direction, the dents caused by the two joint portions are dispersed in the tire circumferential direction and uniformity in the tire circumferential direction can be improved as compared with the case where the two joint portions are provided at the same position in the tire circumferential direction.

The carcass ply includes the first ply including the central portion positioned on the inner side in the tire radial direction of the tread portion and a pair of the side portions extending to the inner side in the tire radial direction from both ends of the central portion, and the second ply having the pair of ply pieces including an inner end portion disposed on an outer side in the tire radial direction with respect to the first ply and positioned in the tread portion and a side portion extending to the inner side in the tire radial direction from the inner end portion.

The second ply includes the pair of ply pieces and is discontinuous. That is, between the inner end portions of the pair of ply pieces, there is a hollow portion in which no ply exists. By employing the second ply having the hollow portion, the weight can be reduced as compared with the case where the second ply is one continuous ply. Further, roiling resistance can be reduced by weight reduction.

In the sidewall portion, two layers of plies, that is, the side portion of the first ply and the side portion of the ply piece of the second ply are disposed. By providing two layers of plies in the sidewall portion in this way, necessary cut resistance is ensured. Further, since plies are provided in two layers, necessary rigidity in the sidewall portion is ensured.

Therefore, it is possible to achieve weight reduction and reduction in rolling resistance due to the weight reduction while ensuring the rigidity and the steering stability due to the rigidity and the cut resistance, and, in addition, to achieve improvement in uniformity in the tire circumferential direction.

The first ply has a joint portion in which both end portions in the tire circumferential direction are joined in a manner overlapping each other, and the joint portion of the first ply and the respective joint portions of the pair of ply pieces of the second ply are provided at different positions in the tire circumferential direction.

By the present configuration, the dents caused by the three joint portions are dispersed in the tire circumferential direction and uniformity in the tire circumferential direction can be improved as compared with the case where the joint portion of the first ply and the respective joint portions of the pair of ply pieces of the second ply are provided at the same position in the tire circumferential direction.

Respective joint portions of the pair of ply pieces of the second ply are preferably provided within an angle range of ±90 degrees with respect to an angular position of 180⋅ degrees in the tire circumferential direction with respect to the joint portion of the first ply.

By the present configuration, the joint portion of the first ply and the two joint portions of the second ply are effectively dispersed and disposed in the tire circumferential direction, so that improvement in uniformity in the tire circumferential direction can be effectively achieved.

The tread rubber constituting the tread portion preferably has a joint portion in which both end portions in the tire circumferential direction are joined, and the joint portion of the tread rubber is preferably provided at the same position in the tire circumferential direction as the joint portion of the first ply.

Since the tread rubber constituting the tread portion is molded in a manner that both end portions overlap each other when the joint is formed, the rubber thickness of the joint portion tends to be thicker than that of the non-joint portion. Therefore, the joint portion of the tread rubber, which is thicker than the non-joint portion of the tread rubber, may appear as a convex portion in the pneumatic tire.

By providing the joint portion of the tread rubber and the joint portion of the first ply at the same position in the tire circumferential direction, the convex portion caused by the joint portion of the tread rubber and the dents caused by the joint portion of the first ply can be combined to improve the uniformity in the tire circumferential direction, as compared with the case where the two joint portions are provided at different positions in the tire circumferential direction.

The joint portion of the sidewall rubber disposed on one side in the tire width direction of a pair of the sidewall rubbers constituting a pair of the sidewall portions is preferably provided at the same position in the tire circumferential direction as the joint portion of the ply piece of the second ply disposed on the one side in the tire width direction.

Since the sidewall rubber constituting the sidewall portion is molded in a manner that both end portions overlap each other when the joint is formed, the rubber thickness of the joint portion tends to be thicker than that of the non-joint portion. Therefore, the joint portion of the sidewall rubber, which is thicker than the non-joint portion of the sidewall rubber, may appear as a convex portion in the pneumatic tire.

By providing the joint portion of the sidewall rubber disposed on one side in the tire width direction and the joint portion of the ply piece of the second ply at the same position in the tire circumferential direction, the convex portion caused by the joint portion of the sidewall rubber and the dent caused by the joint portion of the ply piece of the second ply can be combined to improve the uniformity in the tire circumferential direction, as compared with the case where the two joint portions are provided at different positions in the tire circumferential direction.

The present invention further provides a manufacturing method of a pneumatic tire, the manufacturing method including preparing a carcass ply including a pair of ply pieces disposed separately on both sides in a tire width direction and stretching between a pair of bead cores disposed on both sides in the tire width direction, forming a joint portion obtained by winding one ply piece of the pair of ply pieces in a cylindrical shape and joining both end portions in a circumferential direction of the one ply piece in a manner overlapping each other, forming a joint portion obtained by winding the other ply piece of the pair of ply pieces in a cylindrical shape and joining both end portions in the circumferential direction of the other ply piece in a manner overlapping each other, and providing the joint portion of the other ply piece at a different position in a tire circumferential direction from the joint portion of the one ply piece.

According to the present configuration, in a case where the carcass ply includes a pair of the ply pieces disposed separately on both sides in the tire width direction, the joint portion of the other one of the ply pieces is provided at a different position in the tire circumferential direction from the joint portion of the one of the ply pieces. For this reason, uniformity in the tire circumferential direction can be improved as compared with the case where the two joint portions of a pair of the ply pieces are provided at the same position in the tire circumferential direction, and improvement in uniformity in the tire circumferential direction of the pneumatic tire can be achieved.

According to the pneumatic tire and the manufacturing method of the pneumatic tire according to the present invention, it is possible to achieve improvement in uniformity in the tire circumferential direction.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to an embodiment of the present invention;

FIG. 2 is a meridian cross-sectional view of a tread portion of the pneumatic tire according to the embodiment of the present invention and its surroundings;

FIG. 3 is an enlarged view of Part III of FIG. 1;

FIG. 4 is an enlarged view of Part IV of FIG. 1;

FIG. 5 is a cross-sectional view of a carcass ply along Line V-V of FIG. 2; and

FIG. 6 is a schematic side view of a pneumatic tire for explaining a joint portion of the carcass ply.

### DETAILED DESCRIPTION OF EMBODIMENTS

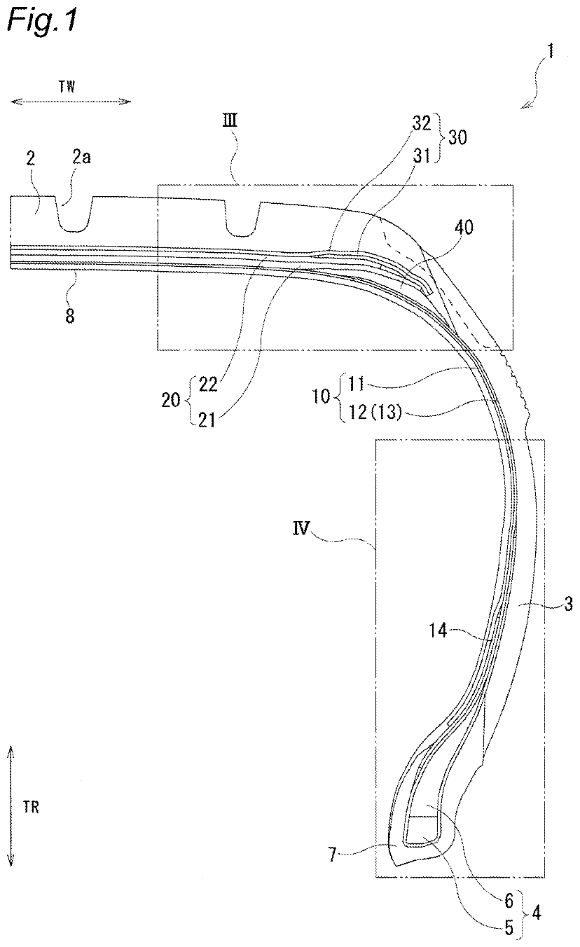

FIGS. 1 to 4 show a pneumatic tire 1 made from rubber according to an embodiment of the present invention.

The pneumatic tire 1 includes a tread portion 2, a pair of sidewall portions 3, and a pair of ring-shaped bead portions 4.

The tread portion 2 extends in the tire width direction (indicated by the reference numeral TW in FIG. 1). A groove 2a is provided on the surface, that is, the tread surface of the tread portion 2.

Each of a pair of the sidewall portions 3 extends from both ends in the tire width direction of the tread portion 2 to the inner side in the tire radial direction (reference numeral TR in FIG. 1).

A pair of the bead portions 4 are disposed on both sides in the tire width direction and disposed in end portions on the inner side in the tire radial direction of a pair of the sidewall portions 3. Each of the bead portions 4 includes a bead core 5 and a bead filler 6. The bead core 5 includes a large number of steel wires bundled in a ring shape. The bead filler 6 has a ring shape and is made from rubber that is harder than rubber that constitutes the tread portion 2 and the sidewall portion 3. The bead filler 6 includes a base end 6a disposed adjacent to the outer side in the tire radial direction of the bead core 5 and a tip end 6b on the side opposite to the base end 6a, and extends in a tapered shape from the base end 6a to the outer side in the tire radial direction toward the tip end 6b. Each of the bead portions 4 includes strip rubber 7 provided to wrap the bead core 5 and the bead filler 6.

The pneumatic tire includes a carcass ply 10 stretching in a toroidal shape between the bead portions 4. In the present embodiment, the carcass ply 10 includes a first carcass ply (hereinafter, referred to as “first ply”) 11 and a second carcass ply (hereinafter, referred to as “second ply”) 12. The second ply 12 is a ply having a hollow portion 13c, while the first ply 11 is a normal ply having no hollow portion. The first and second plies 11 and 12 will be described in detail later. An inner liner 8 is provided on the inner side of the carcass ply 10, that is, on the innermost peripheral surface of the pneumatic tire.

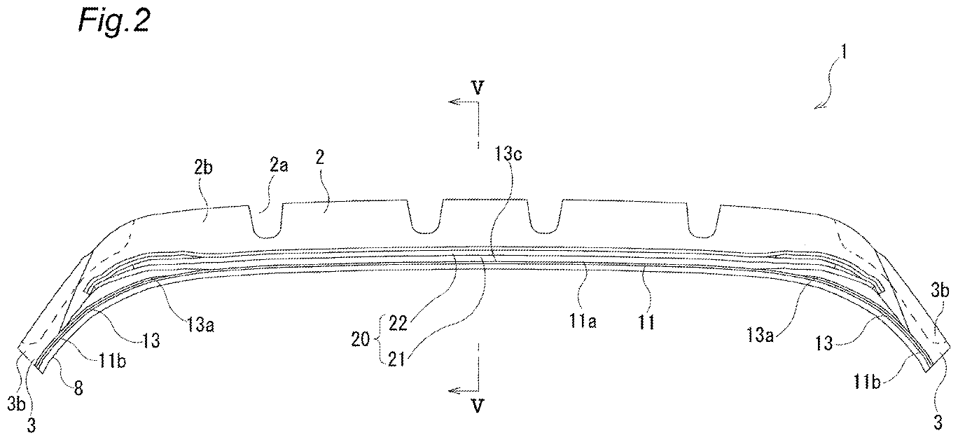

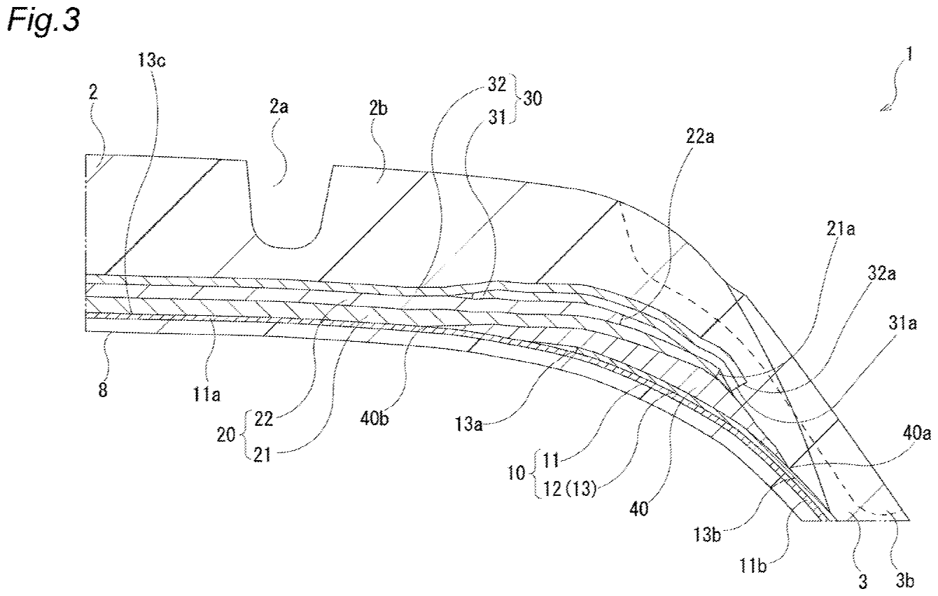

With reference to FIGS. 2 and 3, an endless belt layer 20 is provided on the tread portion 2, more specifically, between the carcass ply 10 and the tread portion 2. In the present embodiment, the belt layer 20 includes two belts 21 and 22. The belt 21 is disposed adjacent to the outer side in the tire radial direction of the carcass ply 10, and the belt 22 is disposed adjacent to the outer side in the tire radial direction of the belt 21. Further, in the present embodiment, the dimension in the tire width direction of the belt 21 in the lower layer is larger than the dimension in the tire width direction of the belt 22 in the upper layer, and an end portion 21a of the belt 21 is positioned closer to the outer side in the tire width direction than an end portion 22a of the belt 22. The belts 21 and 22 are formed by covering a belt cord made from steel or organic fiber with rubber. The belt layer 20 may be composed of one belt, or may include three or more belts.

An endless cap layer 30 is provided adjacent to the outer side in the tire radial direction of the belt layer 20. The cap layer 30 of the present embodiment includes a pair of narrow edge plies 31 that directly cover either of the end portions 21a and 22a of the belts 21 and 22. Further, the cap layer 30 of the present embodiment includes a wide cap ply 32, which is disposed adjacent to the outer side in the tire radial direction of the edge ply 31, as a single sheet that covers the entire belts 21 and 22 including the end portions 21a and 22a. The cap layer 30 may include one ply or three or more plies. Further, the cap layer 30 may be eliminated.

A pair of endless pads 40 made from rubber are disposed between both end portions on the outer side in the tire width direction of the belt layer 20 and the carcass ply 10. The cross-sectional shape of the pad 40 is a flat triangular shape. The positions in the tire width direction of the end portions 21a and 22a of the belts 21 and 22, the end portion 31a on the outer side in the tire width direction of the edge ply 31, and an end portion 32a of the cap ply 32 are set in a region between an end portion 40a on the outer side in the tire width direction of the pad 40 and an end portion 40b on the inner side, that is, a region where the pad 40 exists. The pad 40 may be eliminated.

The first and second plies 11 and 12 constituting the carcass ply 10 will be described.

The first ply 11 is a single ply, whereas the second ply 12 is a discontinuous ply having the hollow portion 13c as described above, and is composed of a pair of ply pieces 13. As will be described later, the first ply 11 and a pair of the ply pieces 13 are joined by a joining tape (joining member) 14. All of the first ply 11 and the ply pieces 13 of the second ply 12 are a strip-shaped sheet in which a plurality of cords arranged in parallel at intervals are covered with rubber.

The first ply 11 and the ply pieces 13 of the second ply 12 may have the same modulus (stress generated when a constant strain is applied) or may have different moduli. Further, the first ply 11 and the ply pieces 13 of the second ply 12 may have the same breaking strength (tensile load at which breaking occurs) or may have different breaking strengths.

The first ply 11 includes a central portion 11a positioned on the inner side in the tire radial direction of the tread portion 2, and a pair of side portions 11b extending from both ends in the tire width direction of the central portion 11a to the inner side in the tire radial direction. A pair of the side portions 11b are similarly configured. The side portion 11b is disposed in the sidewall portion 3. The individual side portions 11b of the first ply 11 include an end portion 11c that terminates on the outer side in the tire radial direction of the bead core 5. In other words, the first ply 11 is not wound up with respect to the bead core 5.

In the present embodiment, the end portion 11c of the side portion 11b of the first ply 11 is positioned closer to the inner side in the tire radial direction than the tip end 6b of the bead filler 6 and closer to the outer side in the tire radial direction than the base end 6a of the bead filler 6. That is, the side portion 11b of the first ply 11 overlaps the bead filler 6.

The second ply 12 is disposed adjacent to the outer side in the tire radial direction of the first ply 11, and is a discontinuous ply composed of a pair of the ply pieces 13 disposed separately on both sides in the tire width direction. A pair of the ply pieces 13 are configured similarly except for the positions of joint portions J2 and J3, which will be described later. The ply piece 13 has the inner end portion 13a disposed between the belt layer 20 and the central portion 11a of the first ply 11. The pad 40 is interposed between the inner end portion 13a and the belt layer 20. The position in the tire width direction of the inner end portion 13a of the ply piece 13 is set in the region on the outer side in the tire width direction of the tread portion 2, more specifically, in the region closer to the inner side in the tire width direction than both the end portions 21a and 22a of the belts 21 and 22 constituting the belt layer 20. The hollow portion 13c is provided in the region at the center in the tire width direction of the tread portion 2, more specifically, in the region between the inner end portions 13a of a pair of the ply pieces 13. In the hollow portion 13c, the second ply 12 does not exist, and only the central portion 11a of the first ply 11 exists.

The ply piece 13 includes a side portion 13b extending to the inner side in the tire radial direction from the inner end portion 13a. The side portion 13b is disposed adjacent to the outer side in the tire width direction of the side portion 11b of the first ply 11.

The ply piece 13 includes a wind-up portion 13d provided continuously with the side portion 13b and wound up from the inner side to the outer side in the tire width direction with respect to the bead core 5. The wind-up portion 13d is terminated in the sidewall portion 3.

The wind-up portion 13d of the ply piece 13 includes an inner portion 13e disposed closer to the inner side in the tire width direction than the bead portion 4, that is, the bead core 5 and the bead filler 6. Further, the wind-up portion 13d includes a winding portion 13f which is provided continuously with the inner portion 13e and is wound around the bead core 5. Further, the wind-up portion 13d includes an outer portion 13g which is provided continuously with the winding portion 13f and is disposed closer to the outer side in the tire width direction than the bead portion 4. The outer portion 13g is disposed so as to overlap the outer side in the tire radial direction of the side portion 13b. An end portion of the outer portion 13g constitutes an outer end portion 13h of the ply piece 13. The outer end portion 13h is positioned closer to the outer side in the tire radial direction than the tip end 6b of the bead filler 6 and is positioned closer to the inner side in the tire radial direction than the tread portion 2.

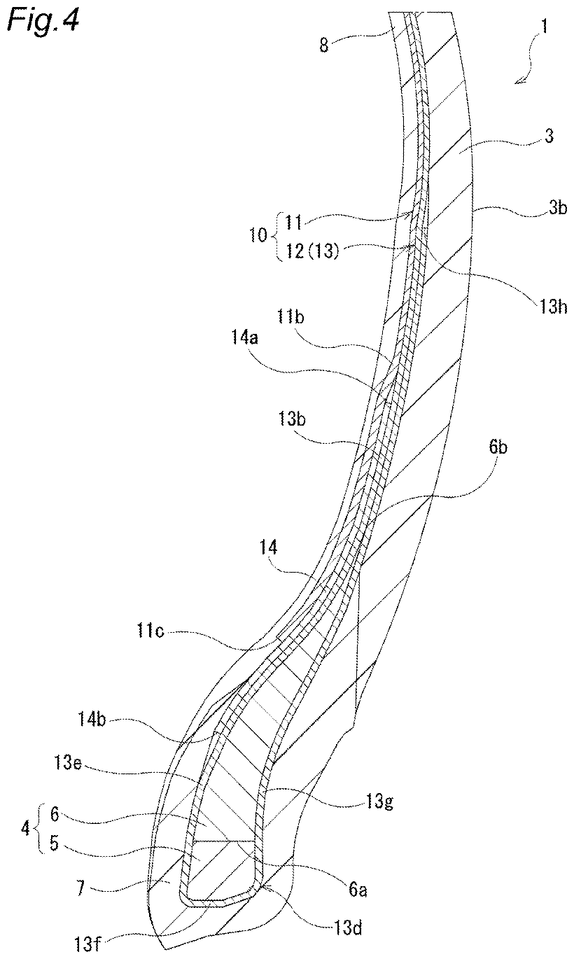

The pneumatic tire 1 includes a pair of joining tapes 14 that join either one of a pair of the side portions 11b of the first ply 11 to the wind-up portion 13d of either one of a pair of the ply pieces 13, more specifically, the inner portion 13e. As most clearly shown in FIG. 4, the joining tape 14 joins a portion including the end portion 11c of the side portion 11b of the first ply 11 to the inner portion 13e of the wind-up portion 13d of the ply piece 13.

The joining tape 14 is made from rubber and preferably has an adhesive strength of 500 gf or more in order to secure the joining strength of the first ply 11 to the second ply 12.

An end portion 14a on the outer side in the tire radial direction of the joining tape 14 is positioned closer to the outer side in the tire radial direction than the tip end 6b of the bead filler 6. The position in the tire radial direction of an end portion 14b on the inner side in the tire radial direction of the joining tape 14 is set between the base end 6a and the tip end 6b of the bead filler 6.

The end portion 11c of the first ply 11 is positioned between the end portion 14b on the inner side and the end portion 14b on the outer side in the tire width direction of the joining tape 14.

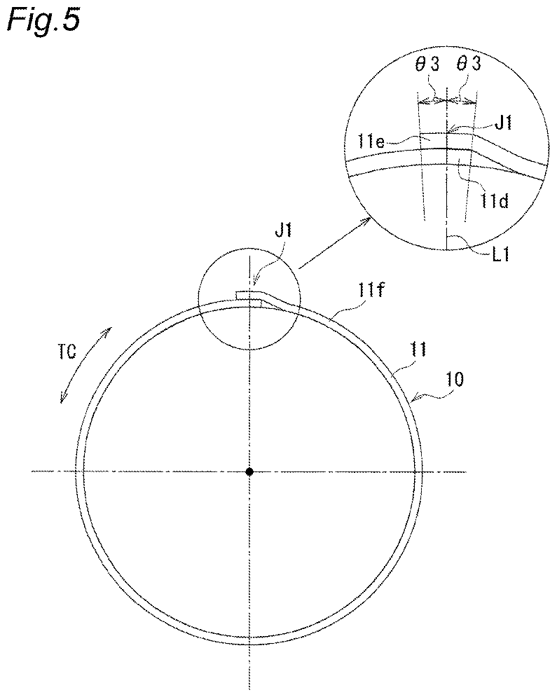

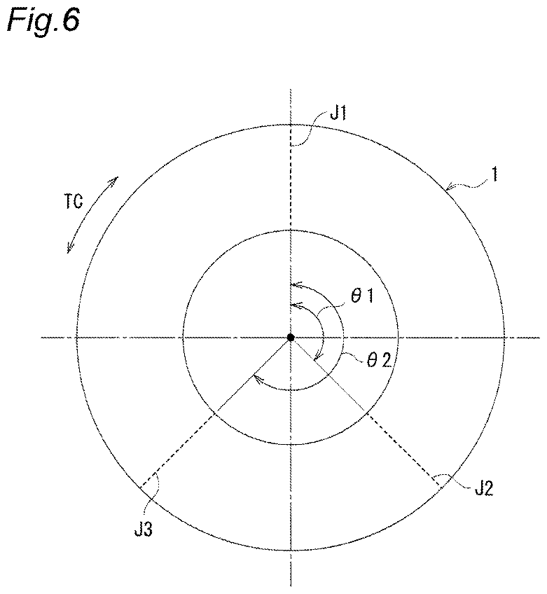

The pneumatic tire 1 according to the present embodiment will be further described with reference to FIGS. 5 and 6.

FIG. 5 shows a cross section of the first ply 11 of the carcass ply 10. As shown in FIG. 5, the first ply 11 of the carcass ply 10 is wound in a cylindrical shape, and one end portion 11d and the other end portion 11e are joined in a manner overlapping each other. A joint portion J1 in which the one end portion 11d and the other end portion 11e, which are both end portions in the circumferential direction of the first ply 11, are joined in a manner overlapping each other, is formed to be thicker than a non-joint portion 11f excluding the joint portion J1 of the first ply 11.

Each of a pair of the ply pieces 13 of the second ply 12 of the carcass ply 10 is also wound in a cylindrical shape in a similar manner to the first ply 11, and one end portion and the other end portion are joined in a manner overlapping each other. A joint portion in which the one end portion and the other end portion, which are both end portions in the circumferential direction of the ply piece 13, are joined in a manner overlapping each other, is formed to be thicker than a non-joint portion excluding the joint portion of the ply piece 13.

In FIG. 6, the joint portion of the first ply 11 is indicated by a broken line as J1, the joint portion of one of the ply pieces 13 of the second ply 12 is indicated by a broken line as J2, and the joint portion of the other one of the ply pieces 13 of the second ply 12 is shown by a broken line as J3. As shown in FIG. 6, in the pneumatic tire 1, the respective joint portions J2 and J3 of a pair of the ply pieces 13 of the second ply 12 are provided at different positions in the tire circumferential direction TC.

The two joint portions J2 and J3 of the second ply 12 are provided at different positions in the tire circumferential direction from the joint portion J1 of the first ply 11. The two joint portions J2 and J3 of the second ply 12 are preferably provided within an angle range of ±90 degrees with respect to the joint portion J1 of the first ply 11 with respect to an angular position of 180 degrees in the tire circumferential direction.

As shown in FIG. 6, assuming that the position in the tire circumferential direction of the joint portion J1 of the first ply 11 around the axial direction of the pneumatic tire 1 is an angular position of 0 degrees, the joint portion J2 of one of the ply pieces 13 of the second ply 12 is preferably provided so that a position θ1 in the tire circumferential direction is between 90 degrees and 270 degrees, and provided within an angle range of ±90 degrees with respect to an angular position of 180 degrees in the tire circumferential direction.

The joint portion J3 of the other of the ply pieces 13 of the second ply 12 is also preferably provided so that a position θ2 in the tire circumferential direction is between 90 degrees and 270 degrees, and provided within an angle range of ±90 degrees with respect to an angular position of 180 degrees in the tire circumferential direction at a different position in the tire circumferential direction TC from the joint portion J2 of the one of the ply pieces 13 of the second ply 12.

In the present embodiment, the joint portion J1 of the first ply 11 is provided so that the position in the tire circumferential direction is an angular position of 0 degrees, the joint portion J2 of one of the ply pieces 13 of the second ply 12 is provided so that the position θ1 in the circumferential direction is an angular position of 120 degrees, and the joint portion J3 of the other one of the ply pieces 13 of the second ply 12 is provided so that the position θ2 in the tire circumferential direction is an angular position of 240 degrees. The first ply 11 and a pair of the ply pieces 13 of the second ply 12 are provided with the joint portions J1, J2, and J3 dispersed in the tire circumferential direction.

As shown in FIG. 5, the position in the tire circumferential direction of the joint portion J1 of the first ply 11 refers to an angular position of a center line L1 extending in the tire radial direction of the joint portion J1, and the center line L1 is a straight line that passes through the center of the tire and divides the joint portion J1 into two equal parts in the tire circumferential direction. The positions in the tire circumferential direction of the two joint portions J2 and J3 of a pair of the ply pieces 13 of the second ply 12 are also set in a similar manner to the first ply 11.

The joint portion J1 of the first ply 11 is preferably at a predetermined angle θ3, for example, within an angle within 2 degrees, in the tire circumferential direction with respect to the center line L1. However, the configuration is not limited to this. The joint portions J2 and J3 of the second ply 12 is also preferably at a predetermined angle, for example, within an angle within 2 degrees, in the tire circumferential direction with respect to the center line of the joint portions J2 and J3. However, the configuration is not limited to this.

In the pneumatic tire 1, tread rubber 2b constituting the tread portion 2 is disposed on the outer side in the tire radial direction of the carcass ply 10, and the tread rubber 2b constitutes the outer surface of the tire. The tread rubber 2b is a strip-shaped sheet, and is formed to be relatively thicker than the carcass ply 10.

The tread rubber 2b is also wound in a cylindrical shape, and one end portion in the circumferential direction and the other end portion in the circumferential direction are joined in a manner overlapping each other. A joint portion in which the one end portion and the other end portion, which are both end portions in the circumferential direction of the tread rubber 2b, are joined in a manner overlapping each other, is formed to be thicker than a non-joint portion excluding the joint portion of the tread rubber 2b.

The joint portion of the tread rubber 2b is provided at the same position in the tire circumferential direction as the joint portion J1 of the first ply 11. The position in the tire circumferential direction of the joint portion of the tread rubber 2b is also set in a similar manner to the joint portion J1 of the first ply 11.

Further, in the pneumatic tire 1, a pair of sidewall rubbers 3b constituting a pair of the sidewall portions 3 are disposed on the outer side in the tire width direction of the carcass ply 10, and a pair of the sidewall rubbers 3b constitute the outer surface of the tire. The sidewall rubber 3b is a strip-shaped sheet, and is formed to be relatively thicker than the carcass ply 10.

Each of a pair of the sidewall rubbers 3b is also wound in a cylindrical shape, and one end portion in the circumferential direction and the other end portion in the circumferential direction are joined in a manner overlapping each other. A joint portion in which the one end portion and the other end portion, which are both end portions in the circumferential direction of the sidewall rubber 3b, are joined in a manner overlapping each other, is formed to be thicker than a non-joint portion excluding the joint portion of the sidewall rubber 3b.

The joint portion of the sidewall rubber 3b disposed on one side in the tire width direction of a pair of the sidewall rubbers 3b is provided at the same position in the tire circumferential direction as the joint portion of the ply pieces 13 of the second ply 12 disposed on one side in the tire width direction of a pair of the ply pieces 13 of the second ply 12.

The joint portion of the sidewall rubber 3b disposed on the other side in the tire width direction of a pair of the sidewall rubbers 3b is provided at the same position in the tire circumferential direction as the joint portion of the ply piece 13 of the second ply 12 disposed on the, other side in the tire width direction of a pair of the ply pieces 13 of the second ply 12.

In the pneumatic tire 1, the joint portion J2 of one of the ply pieces 13 of the second ply 12 of the carcass ply 10 and the joint portion of the sidewall rubber 3b disposed on the outer side in the tire width direction of the ply piece 13 are provided at the same position in the tire circumferential direction. Further, the joint portion J3 of the other one of the ply pieces 13 of the second ply 12 of the carcass ply 10 and the joint portion of the sidewall rubber 3b disposed on the outer side in the tire width direction of the ply piece 13 are provided at the same position in the tire circumferential direction.

Next, a manufacturing method of the pneumatic tire 1 configured in this way will be described.

When manufacturing the pneumatic tire 1, first, tire components for molding a cylindrical tread band, such as the tread rubber 2b constituting the tread portion 2 and the belts 21 and 22, are prepared. On the other hand, tire components for molding a cylindrical carcass band, such as the carcass ply 10 that includes the first ply 11 and the second ply 12 and is stretched between a pair of the bead cores 5 and the inner liner 8, are prepared.

Then, tire components such as the inner liner 8 and the carcass ply 10 are wound around a molding drum to mold a cylindrical carcass band. In the molding of the carcass band, the first ply 11 is wound in a cylindrical shape, and the joint portion J1 in which both the end portions 11d and 11e in the circumferential direction of the first ply 11 are joined in a manner overlapping each other is formed.

Next, one of the ply pieces 13 of the second ply 12 is wound in a cylindrical shape and the joint portion J2 in which both end portions in the circumferential direction of the one of the ply pieces 13 are joined in a manner overlapping each other is formed, and the other one of the ply pieces 13 of the second ply 12 is wound in a cylindrical shape and the joint portion J3 in which both end portions in the circumferential direction of the other one of the ply pieces 13 are joined in a manner overlapping each other is formed. A pair of the ply pieces 13 may be wound simultaneously or separately.

The carcass band is transferred to another molding drum, and, after that, the bead core 5 and bead filler 6 are assembled on both side portions of the carcass band, and the carcass band is folded back on both sides in the drum width direction around the bead core 5, so that a cylindrical green case is molded.

On the other hand, tire components such as a belt and tread rubber are further wound around another molding drum to mold a cylindrical tread band. Then, after the tread band is transported to the outer side in the radial direction of the green case, the green case is bulged in a toroidal shape to the outer side in the radial direction, the outer surface of the green case is bonded to the inner surface of the tread band, and a carcass tread bond body is molded.

Next, a pair of sidewall rubbers 9 are wound around the carcass tread bond body to mold a green tire. The molded green tire is vulcanized and molded vulcanization molding machine (not shown) including a tire vulcanization mold, and the pneumatic tire 1 is manufactured.

A pair of the sidewall rubbers 9 are wound and molded after the carcass tread bond body is molded. However, it is also possible to wind and mold the sidewall rubber 9 when the carcass band is molded.

As described above, the joint portion J3 of the other one of the ply pieces 13 of the second ply 12 is provided at a position different in the tire circumferential direction from the joint portion J2 of one of the ply pieces 13. The two joint portions J2 and J3 of a pair of the ply pieces 13 of the second ply 12 are provided at different positions in the tire circumferential direction from the joint portion J1 of the first ply 11.

The joint portion of the tread rubber 2b is provided at the same position in the tire circumferential direction as the joint portion J1 of the first ply 11. Joint portions of sidewall rubber 3b disposed on one side and the other side in the tire width direction are provided at the same positions in the tire circumferential direction as the joint, portions of the ply pieces 13 of the second ply 12 disposed on one side and the ether side in the tire width direction.

In the present embodiment, the second ply 12 includes the wind-up portion 13d wound up with respect to the bead core 5, and, although the first ply 11 is not wound up with respect to the bead core 5, the first ply 11 can include a wind-up portion that is wound up with respect to the bead core 5. Further, both the first ply 11 and the second ply 12 may include a wind-up portion wound up with respect to the bead core 5.

As described above, the pneumatic tire 1 according to the present embodiment includes the carcass ply 10 stretching between a pair of the bead cores 5 disposed on both sides in the tire width direction, and the carcass ply 10 includes a pair of the ply pieces 13 disposed separately on both sides in the tire width direction. Each of a pair of the ply pieces 13 has the joint portions J2 and J3 in which both end portions in the tire circumferential direction are joined in a manner overlapping each other, and the two joint portions J2 an J3 of a pair of the ply pieces 13 are provided at different positions in the tire circumferential direction.

In this manner, in a case where the carcass ply 10 includes pair of the ply pieces 13 disposed separately on both sides in the tire width direction, the two joint portions J2 and J3 of a pair of the ply pieces 13 are provided at different positions in the tire circumferential direction. For this reason, as compared with the case where the two joint portions J2 and J3 are provided at the same position in the tire circumferential direction, the joint portions J2 and J3 are dispersed in the tire circumferential direction and uniformity in the tire circumferential direction of the pneumatic tire 1 can be improved.

The joint portions J2 and J3 of the ply piece 13 have increased rigidity as compared with the non-joint portion of the ply piece 13. For this reason, the joint portions J2 and J3 of the ply piece 13 are less likely to bulge and deform than the non-joint portion when the tire is filled with internal pressure and bulged and deformed. Therefore, the joint portions J2 and J3 of the ply piece 13 may appear as dents in the pneumatic tire.

By providing the two joint portions J2 and J3 of a pair of the ply pieces 13 at different positions in the tire circumferential direction, the dents caused by the two joint portions J2 and J3 are dispersed in the tire circumferential direction and uniformity in the tire circumferential direction of the pneumatic tire 1 can be improved as compared with the case where the two joint portions J2 and J3 are provided at the same position in the tire circumferential direction.

Further, the carcass ply 10 includes the first ply 11 including the central portion 11a positioned on the inner side in the tire radial direction of the tread portion 2 and a pair of the side portions 11b extending to the inner side in the tire radial direction from both ends of the central portion 11a, and the second ply 12 having a pair of the ply pieces 13 including the inner end portion 13a disposed on the outer side in the tire radial direction with respect to the first ply 11 and positioned in the tread portion 2 and the side portion 13b extending to the inner side in the tire radial direction from the inner end portion 13a.

The second ply 12 includes a pair of the ply pieces 13 and is discontinuous. That is, between the inner end portions 13a of a pair of the ply pieces 13, there is the hollow portion 13c in which no ply exists. By employing the second ply 12 having the hollow portion 13c, the weight can be reduced as compared with the case where the second ply 12 is one continuous ply. Further, rolling resistance can be reduced by weight reduction.

In the sidewall portion 3, two layers of plies, that is, the side portion 11b of the first ply 11 and the side portion 13b of the ply piece 13 of the second ply 12 are disposed. By providing two layers of plies in the sidewall portion 3 in this way, necessary cut resistance is ensured. Further, since plies are provided in two layers, necessary rigidity in the sidewall portion 3 is ensured.

Therefore, it is possible to achieve weight reduction and reduction in rolling resistance due to the weight reduction while ensuring the rigidity and the steering stability due to the rigidity and the cut resistance, and, in addition, to achieve improvement in uniformity in the tire circumferential direction.

Further, the first ply 11 has the joint portion J1 in which both end portions in the tire circumferential direction are joined in a manner overlapping each ether, and the joint portion J1 of the first ply 11 and the two joint portions J2 and J3 of a pair of the ply pieces 13 of the second ply 12 are provided at different positions in the tire circumferential direction. In this manner, the dents caused by the three joint portions J1, J2, and J3 are dispersed in the tire circumferential direction and uniformity in the tire circumferential direction can be improved as compared with the case where the joint portion J1 of the first ply 11 and the two joint portions J2 and J3 of a pair of the ply pieces 13 of the second ply 12 are provided at the same position in the tire circumferential direction.

Further, the two joint portions J2 and J3 of a pair of the ply pieces 13 of the second ply 12 are provided within an angle range of ±90 degrees with respect to the angular position of 180 degrees in the tire circumferential direction with respect to the joint portion J1 of the first ply 11. In this manner, the joint portion J1 of the first ply 11 and the two joint portions J2 and J3 of the second ply 12 are effectively dispersed and disposed in the tire circumferential direction, so that improvement in uniformity in the tire circumferential direction can be effectively achieved.

Further, the tread rubber 2b constituting the tread portion 2 has a joint portion in which both end portions in the tire circumferential direction are joined, and the joint portion of the tread rubber 2b is provided at the same position in the tire circumferential direction as the joint portion J1 of the first ply 11.

Since the tread rubber 2b constituting the tread portion 2 is molded in a manner that both end portions overlap each other when the joint is formed, the rubber thickness of the joint portion tends to be thicker than that of the non-joint portion. Therefore, the joint portion of the tread rubber 2b, which is thicker than the non-joint portion of the tread rubber 2b, may appear as a convex portion in the pneumatic tire 1.

By providing the joint portion of the tread rubber 2b and the joint portion J1 of the first ply 11 at the same position in the tire circumferential direction, the convex portion caused by the joint portion of the tread rubber 2b and the dents caused by the joint portion J1 of the first ply 11 can be combined to improve the uniformity in the tire circumferential direction, as compared with the case where the two joint portions J1 are provided at different positions in the tire circumferential direction.

Further, the joint portion of the sidewall rubber 3b disposed on one side in the tire width direction of a pair of the sidewall rubbers 3b constituting a pair of the sidewall portions 3 is provided at the same position in the tire circumferential direction as the joint portion of the ply pieces 13 of the second ply 12 disposed on one side in the tire width direction.

Since the sidewall rubber 3b constituting the sidewall portion 3 is molded in a manner that both end portions overlap each other when the joint is formed, the rubber thickness of the joint portion tends to be thicker than that of the non-joint portion. Therefore, the joint portion of the sidewall rubber 3b, which is thicker than the non-joint portion of the sidewall rubber 3b, may appear as a convex portion in the pneumatic tire 1.

By providing the joint portion of the sidewall rubber 3b disposed on one side in the tire width direction and the joint portion of the ply pieces 13 of the second ply 12 at the same position in the tire circumferential direction, the convex portion caused by the joint portion of the sidewall rubber 3b and the dents caused by the joint portion of the ply pieces 13 of the second ply 12 can be combined to improve the uniformity in the tire circumferential direction, as compared with the case where the two joint portions are provided at different positions in the tire circumferential direction.

Further, in the manufacturing method of the pneumatic tire 1 according to the present embodiment, the carcass ply 10 that includes a pair of the ply pieces 13 disposed separately on both sides in the tire width direction and is stretched between a pair of the bead cores 5 disposed on both sides in the tire width direction is prepared. Then, one of the ply pieces 13 is wound in a cylindrical shape and both end portions in the circumferential direction are joined in a manner overlapping each other to form the joint portion J2, and the other one of the ply pieces 13 is wound in a cylindrical shape and both end portions in the circumferential direction of the other one of the ply pieces 13 are joined in a manner overlapping each other to form the joint portion J3. The joint portion J3 of the other one of the ply pieces 13 is provided at a different position in the tire circumferential direction from the joint portion J2 of the one of the ply pieces 13.

In this manner, in a case where the carcass ply 10 includes a pair of the ply pieces 13 disposed separately on both sides in the tire width direction, the joint portion J3 of the other one of the ply pieces 13 is provided at a different position in the tire circumferential direction from the joint portion J2 of the one of the ply pieces 13. For this reason, uniformity in the tire circumferential direction can be improved as compared with the case where the two joint portions J2 and J3 of a pair of the ply pieces 13 are provided at the same position in the tire circumferential direction, and improvement in uniformity in the tire circumferential direction of the pneumatic tire 1 can be achieved.

The present invention is not limited to the illustrated embodiment, and various improvements and design changes can be made without departing from the gist of the present invention.

What is claimed is:

1. A pneumatic tire comprising a carcass ply stretching between a pair of bead cores disposed on both sides in a tire width direction, wherein
the carcass ply includes a pair of ply pieces disposed separately on both sides in the tire width direction,
each of the pair of ply pieces has a joint portion in which both end portions in a tire circumferential direction are joined in a manner overlapping each other, and
respective joint portions of the pair of ply pieces are provided at different positions in the tire circumferential direction.

2. The pneumatic tire according to claim 1, wherein
the carcass ply includes a first ply including a central portion positioned on an inner side in a tire radial direction of a tread portion and a pair of side portions extending to an inner side in the tire radial direction from both ends of the central portion, and a second ply having the pair of ply pieces, each of which including an inner end portion disposed on an outer side in the tire radial direction with respect to the first ply and positioned in the tread portion and a side portion extending to an inner side in the tire radial direction from the inner end portion.

3. The pneumatic tire according to claim 2, wherein
the first ply has a joint portion in which both end portions in the tire circumferential direction are joined in a manner overlapping each other, and
the joint portion of the first ply and respective joint portions of a pair of ply pieces of the second ply are provided at different positions in the tire circumferential direction.

4. The pneumatic tire according to claim 3, wherein
respective joint portions of the pair of ply pieces of the second ply are provided within an angle range of ±90 degrees with respect to an angular position of 180 degrees in the tire circumferential direction with respect to the joint portion of the first ply.

5. The pneumatic tire according to claim 3, wherein
the joint portion of the one ply piece of the second ply is provided at an angular position of 120 degrees on one side in the tire circumferential direction with respect to the joint portion of the first ply, and
the joint portion of the other ply piece of the second ply is provided at an angular position of 240 degrees on one side in the tire circumferential direction. with respect to the joint portion of the first ply.

6. The pneumatic tire according to claim 2, wherein
tread rubber constituting the tread portion has a joint portion in which both end portions in the tire circumferential direction are joined, and
the joint portion of the tread rubber is provided at the same position in the tire circumferential direction as a joint portion of the first ply.

7. The pneumatic tire according to claim 2, further comprising a pair of sidewall portions extending to an inner side in the tire radial direction from both ends in the tire width direction of the tread portion, wherein
each of a pair of sidewall rubbers constituting the pair of sidewall portions has a joint portion in which both end portions in the tire circumferential direction are joined, and
the joint portion of the sidewall rubber disposed on one side in the tire width direction of the pair of sidewall rubbers is provided at the same position in the tire circumferential direction as a joint portion of a ply piece of the second ply disposed on the one side in the tire width direction of the pair of ply pieces of the second ply.

8. A manufacturing method of a pneumatic tire, the manufacturing method comprising:
preparing a carcass ply including a pair of ply pieces disposed separately on both sides in a tire width direction and stretching between a pair of bead cores disposed on both sides in the tire width direction;
forming a joint portion obtained by winding one ply piece of the pair of ply pieces in a cylindrical shape and joining both end portions in a circumferential direction of the one ply piece in a manner overlapping each other;
forming a joint portion obtained by winding the other ply piece of the pair of ply pieces in a cylindrical shape and joining both end portions in the circumferential direction of the other ply piece in a manner overlapping each other; and
providing the joint portion of the other ply piece at a different position in a tire circumferential direction from the joint portion of the one ply piece.
